(19) United States
(12) Patent Application Publication
(10) Pub. No.: US 2015/0209897 A1
(43) Pub. Date: Jul. 30, 2015

(54) POLARIZED LASER FOR PATTERNING OF SILVER NANOWIRE TRANSPARENT CONDUCTIVE FILMS

(71) Applicant: Carestream Health, Inc., Rochester, NY (US)

(72) Inventors: Andrew T. Fried, Woodbury, MN (US); Jeffrey Treptau, Lakeville, MN (US); Paul C. Schubert, Marine on Saint Croix, MN (US)

(21) Appl. No.: 14/562,792

(22) Filed: Dec. 8, 2014

Related U.S. Application Data
(60) Provisional application No. 61/931,831, filed on Jan. 27, 2014.

(51) Int. Cl. B23K 26/00; B23K 26/06

(52) U.S. Cl. CPC B23K 26/0048; B23K 26/0635; Y10S 977/783; Y10S 977/889; Y10S 977/932; B82Y 40/00

(57) ABSTRACT

A method comprising providing an electrically conductive film comprising a first set of electrically conductive nanostructures in a first region that exhibits a first conductivity and a second set of electrically conductive nanostructures in a second region that exhibits a second conductivity, and irradiating the first region of the electrically conductive film with a polarized laser beam having an ultraviolet light frequency at a pulse duration less than 100 nanoseconds, so that, after irradiating the first region of the electrically conductive film, the first region exhibits a third conductivity that is less than the second conductivity.

### CROSS REFERENCE TO RELATED APPLICATIONS

This application claims the benefit of U.S. Provisional Application No. 61/931,831, filed Jan. 27, 2014, entitled “POLARIZED LASER FOR PATTERNING OF SILVER NANOWIRE TRANSPARENT CONDUCTIVE FILMS,” which is hereby incorporated by reference in its entirety.

### BACKGROUND

U.S. Pat. No. 3,653,741 to Marks discloses apparatuses comprising orientable particles and methods of orienting these particles by applying a force field. U.S. Patent Application Publication 2009/0052029 to Dai et al. discloses apparatuses comprising orientable silver nanowires and methods of orienting these nanowires by applying a flow-induced shear force. U.S. Pat. No. 8,178,028 to Gandhi discloses laser patterning of nanostructure film. WO 2013/095971 to 3M discloses laser patterning of silver nanowire-based transparent electrically conducting coatings. U.S. Pat. No. 7,786,024 to Stumbo et al. discloses selective processing of semiconductor nanowires by polarized visible radiation. U.S. Pat. No. 8,269,108 to Kuraishi et al. discloses forming gaps in transparent conductive films using a laser. U.S. Pat. No. 8,174,667 to Allemand et al discloses nanowire-based transparent conductors and applications thereof.

### SUMMARY

In some embodiments, a method is disclosed as comprising providing an electrically conductive film that may comprise a first set of electrically conductive nanostructures in a first region that exhibits a first conductivity and a second set of electrically conductive nanostructures in a second region that exhibits a second conductivity and irradiating the first region of the electrically conductive film with a polarized laser beam that may have an ultraviolet light frequency at a short pulse duration, where, after irradiating the first region of the electrically conductive film, the first region may exhibit a third conductivity that is less than the second conductivity.

In some embodiments, the polarized laser beam may have a polarization direction. In some embodiments, at least one of the electrically conductive nanostructures in the first set of electrically conductive nanostructures in the first region has an orientation direction that is aligned substantially perpendicular to the polarization direction. In some embodiments, the polarized light beam may have an ultraviolet light frequency of about 355 nm. In some embodiments, the pulse duration may be less than about 1 nanosecond. In some embodiments, the pulse duration may be about 100 picoseconds. In some embodiments, the pulse duration may be less than about 15 picoseconds.

In some embodiments, the electrically conductive film may comprise a top coat layer disposed on an electrically conductive layer. In some embodiments, the electrically conductive layer may comprise the first set of electrically conductive nanostructures and the second set of electrically conductive nanostructures. In some embodiments, after irradiating the first region of the electrically conductive film, the top coat layer may exhibit minimal damage.

In some embodiments, the electrically conductive film may comprise a substrate. In some embodiments, the electrically conductive layer may be disposed on the substrate. In some embodiments, after irradiating the first region of the electrically conductive film, the substrate exhibits minimal damage.

In some embodiments, the electrically conductive film comprises a hard coat layer. In some embodiments, the substrate may be disposed on the hard coat layer. In some embodiments, after irradiating the first region of the electrically conductive film, the hard coat layer may exhibit minimal damage.

In some embodiments, the top coat layer may comprise a polymer. In some embodiments, the electrically conductive layer may comprise a polymer matrix. In some embodiments, the first set of electrically conductive nanostructures and the second set of electrically conductive nanostructures may be embedded in the polymer matrix. In some embodiments, the substrate may comprise a first polymer. In some embodiments, the hard coat layer may comprise a second polymer. The first polymer and the second polymer may be same or different polymers.

In some embodiments, the first set of electrically conductive nanostructures and the second set of electrically conductive nanostructures may comprise silver nanowires. In some embodiments, the silver nanowires may have an average diameter. In some embodiments, the average diameter may be between about 10 nm to about 40 nm.

In some embodiments, a method is disclosed as comprising providing an electrically conductive film comprising a first set of electrically conductive nanostructures in a first region that exhibits a first conductivity and a second set of electrically conductive nanostructures in a second region that exhibits a second conductivity, and irradiating the first region of the electrically conductive film with a polarized laser beam having a polarization direction, where at least one of the electrically conductive nanostructures in the first set of electrically conductive nanostructures in the first region has an orientation direction that is aligned substantially perpendicular to the polarization direction, where, after irradiating the first region of the electrically conductive film, the first region exhibits a third conductivity that is less than the second conductivity.

In some embodiments, the polarized laser beam may have an ultraviolet light frequency. In some embodiments, the polarized laser beam may have an ultraviolet light frequency of about 355 nm. In some embodiments, the first region of the electrically conductive film may be irradiated with the polarized laser beam at an ultra-short pulse duration. In some embodiments, the first region of the electrically conductive film may be irradiated with the polarized laser beam at a short pulse duration. In some embodiments, the pulse duration may be less than about 100 picoseconds. In some embodiments, the pulse duration may be less than about 1 nanosecond. In some embodiments, the pulse duration may be less than about 100 picoseconds. In some embodiments, the pulse duration may be less than about 15 picoseconds.

In some embodiments, the electrically conductive film may comprise a top coat layer disposed on an electrically conductive layer. In some embodiments, the electrically conductive layer may comprise the first set of electrically conductive nanostructures and the second set of electrically conductive nanostructures. In some embodiments, after irradiating the first region of the electrically conductive film, the top coat layer may exhibit minimal damage.

In some embodiments, the electrically conductive film may comprise a substrate. In some embodiments, the electrically conductive layer may be disposed on the substrate. In some embodiments, after irradiating the first region of the electrically conductive film, the substrate may exhibit minimal damage.

In some embodiments, the electrically conductive film may comprise a hard coat layer. In some embodiments, the substrate may be disposed on the hard coat layer. In some embodiments, after irradiating the first region of the electrically conductive film, the hard coat layer may exhibit minimal damage. In some embodiments, after irradiating the first region of the electrically conductive film, the electrically conductive layer may exhibit minimal damage.

In some embodiments, the top coat layer comprises a polymer. In some embodiments, the electrically conductive layer may comprise a polymer matrix. In some embodiments, the first set of electrically conductive nanostructures and the second set of electrically conductive nanostructures may be embedded in the polymer matrix. In some embodiments, the substrate may comprise a polymer. In some embodiments, the hard coat layer may comprise a polymer.

In some embodiments, the first set of electrically conductive nanostructures and the second set of electrically conductive nanostructures may comprise silver nanowires. In some embodiments, the silver nanowires may have an average diameter, the average diameter being between about 20 nm and 40 nm.

In some embodiments, a method is disclosed as comprising providing an electrically conductive film comprising a first set of electrically conductive nanostructures in a first region that exhibits a first conductivity and a second set of electrically conductive nanostructures in a second region that exhibits a second conductivity, and irradiating the first region of the electrically conductive film with a polarized laser beam having a polarization direction, wherein at least one of the electrically conductive nanostructures in the first set of electrically conductive nanostructures in the first region has an orientation direction that is aligned substantially parallel to the polarization direction, where, after irradiating the first region of the electrically conductive film, the first region exhibits a third conductivity that is less than the second conductivity.

In some embodiments, the polarized laser beam has a visible or infrared light frequency. In some embodiments, the polarized laser beam has a visible light frequency of about 532 nm. In some embodiments, the polarized laser beam has an infrared light frequency of about 1064 nm. In some embodiments, the first region of the electrically conductive film is irradiated with the polarized laser beam at a short pulse duration. In some embodiments, the first region of the electrically conductive film is irradiated with the polarized laser beam at an ultra-short pulse duration. In some embodiments, the first region of the electrically conductive film is irradiated with the polarized beam at a pulse duration of less than about 100 nanoseconds. In some embodiments, the first region of the electrically conductive film is irradiated with the polarized beam at a pulse duration of less than about 1 nanosecond. In some embodiments, the first region of the electrically conductive film is irradiated with the polarized beam at a pulse duration of less than about 100 picoseconds. In some embodiments, the first region of the electrically conductive film is irradiated with the polarized beam at a pulse duration of less than about 15 picoseconds.

In some embodiments, the electrically conductive film comprises a top coat layer disposed on an electrically conductive layer that comprises the first set of electrically conductive nanostructures and the second set of electrically conductive nanostructures, and where, after irradiating the first region of the electrically conductive film, the top coat layer exhibits minimal damage. In some embodiments, the electrically conductive film comprises a substrate, the electrically conductive layer being disposed on the substrate, and where, after irradiating the first region of the electrically conductive film, the substrate exhibits minimal damage. In some embodiments, the electrically conductive film comprises a hard coat layer, the substrate being disposed on the hard coat layer, and where, after irradiating the first region of the electrically conductive film, the hard coat layer exhibits minimal damage. In some embodiments, after irradiating the first region of the electrically conductive film, the electrically conductive layer exhibits minimal damage. In some embodiments, the top coat layer comprises a polymer. In some embodiments, the electrically conductive layer comprises a polymer matrix, the first set of electrically conductive nanostructures and the second set of electrically conductive nanostructures being embedded in the polymer matrix. In some embodiments, the substrate comprises a polymer. In some embodiments, the hard coat layer comprises a polymer. In some embodiments, the first set of electrically conductive nanostructures and the second set of electrically conductive nanostructures comprise silver nanowires. In some embodiments, the silver nanowires has an average diameter, the average diameter being about 20-40 nm.

In some embodiments, in a system comprising an electrically conductive film comprising a first set of electrically conductive nanostructures in a first region that exhibits a first conductivity and a second set of electrically conductive nanostructures in a second region that exhibits a second conductivity, and a polarized laser capable of emitting a polarized laser beam having a polarization direction, a method of irradiating the first region of the electrically conductive film is disclosed, the method comprising orienting the polarization direction of the polarized laser beam to be substantially perpendicular to at least one of the electrically conductive nanostructures in the first set of electrically conductive nanostructures in the first region, and irradiating the at least one of the electrically conductive nanostructures with the polarized laser beam in the oriented polarization direction.

In some embodiments, in a system comprising an electrically conductive film comprising a first set of electrically conductive nanostructures in a first region that exhibits a first conductivity and a second set of electrically conductive nanostructures in a second region that exhibits a second conductivity, and a polarized laser capable of emitting a polarized laser beam having a polarization direction, a method of irradiating the first region of the electrically conductive film is disclosed, the method comprising orienting the polarization direction of the polarized laser beam to be substantially parallel to at least one of the electrically conductive nanostructures in the first set of electrically conductive nanostructures in the first region, and irradiating the at least one of the electrically conductive nanostructures with the polarized laser beam in the oriented polarization direction.

In some embodiments, a method is disclosed as comprising providing an electrically conductive film comprising a first set of electrically conductive nanostructures in a first region that exhibits a first conductivity and a second set of electrically conductive nanostructures in a second region that exhibits a second conductivity, and irradiating the first region of the electrically conductive film with a polarized laser beam, where, after irradiating the first region of the electrically conductive film, the first region exhibits a third conductivity that is less than the second conductivity. In some embodiments, the laser beam is linearly polarized. In some embodiments, the laser beam is radially polarized. In some embodiments, the laser beam is circularly polarized.

In some embodiments, a method is disclosed as comprising providing an electrically conductive film comprising a first set of electrically conductive nanostructures in a first region that exhibits a first conductivity and a second set of electrically conductive nanostructures in a second region that exhibits a second conductivity, and irradiating the first region of the electrically conductive film with a polarized laser beam having a polarization direction to form a first pattern aligned with the polarization direction at a first laser power and a second pattern aligned substantially perpendicular to the polarization direction at a second laser power, the second laser power being less than the first laser power, where, after irradiating the first region of the electrically conductive film, the first region exhibits a third conductivity that is less than the second conductivity.

In some embodiments, in a system comprising an electrically conductive film comprising a first set of electrically conductive nanostructures in a first region that exhibits a first conductivity and a second set of electrically conductive nanostructures in a second region that exhibits a second conductivity, and a polarized laser capable of emitting a polarized laser beam having a polarization direction, a method of irradiating the first region of the electrically conductive film to form a first pattern is disclosed, the method comprising: orienting the polarization direction of the polarized laser beam, and irradiating the first region to form the first pattern along the polarization direction.

In some embodiments, in a system comprising an electrically conductive film comprising a first set of electrically conductive nanostructures in a first region that exhibits a first conductivity, a second set of electrically conductive nanostructures in a second region that exhibits a second conductivity, a third set of electrically conductive nanostructures in a third region that exhibits a third conductivity, a polarized laser capable of emitting a polarized laser beam having a polarization direction to create a pattern comprising lines having a lengthwise direction, and a rotating wave plate to orient the polarization direction substantially parallel or substantially perpendicular to the lengthwise direction of lines in the pattern, a method of irradiating the electrically conductive film to form a pattern comprising lines having a lengthwise direction is disclosed, the method comprising orienting the polarization direction of the polarized laser beam into a first polarization direction, and irradiating the first region to form a first pattern comprising lines having a lengthwise direction aligned along the first polarization direction, where the first polarization direction is either substantially parallel or substantially perpendicular to the lengthwise direction of the lines of a first pattern. In some embodiments, the method further comprises orienting the polarization direction of the polarized laser beam into a second polarization direction, and irradiating the second region to form a second pattern comprising lines having a lengthwise direction aligned along the second polarization direction, where the second polarization direction is either substantially parallel or substantially perpendicular to the lengthwise direction of the lines of the second pattern.

### DESCRIPTION OF FIGURES

FIG. 1 shows an embodiment of an electrically conductive film.

FIG. 2 shows an embodiment of a laser patterned electrically conductive film.

FIG. 3 shows an embodiment of a process in which a nanowire is separated into nanostructures of smaller lengths.

FIG. 4 shows a side view of an embodiment of a laser system.

FIG. 5 shows a top view of an embodiment of an electrically conductive film that may be subjected to the laser system of FIG. 4.

FIG. 6 shows a graph of the absorption width versus wavelength for 40 nm diameter silver nanowires based on the Mie Theory of Light Scattering, where “TE” refers to the transverse electric waves and “TM” refers to the transverse magnetic waves.

FIGS. 7 and 8 show scanning electron microscope images of the electrically conductive film after laser irradiation using a laser power of 1.8 W at magnifications of 1000 times and 5000 times, respectively.

FIGS. 9 and 10 show scanning electron microscope images of an electrically conductive film after laser irradiation at magnifications of 1000 times and 5000 times, respectively.

FIGS. 11 and 12 show scanning electron microscope images of the electrically conductive film after laser irradiation at magnifications of 1000 times and 5000 times, respectively.

FIGS. 13 and 14 show scanning electron microscope images of the electrically conductive film after laser irradiation at magnifications of 1000 times and 5000 times, respectively.

FIG. 15A shows a roll of film from which samples are cut for laser processing.

FIG. 15B shows a sample of film, such as that obtained from the roll of FIG. 15A, that is subjected to laser processing.

### DESCRIPTION

All publications, patents, and patent documents referred to in this document are incorporated by reference in their entirety, as though individually incorporated by reference.

U.S. Provisional Application No. 61/931,831, filed Jan. 27, 2014, entitled “POLARIZED LASER FOR PATTERNING OF SILVER NANOWIRE TRANSPARENT CONDUCTIVE FILMS,” is hereby incorporated by reference in its entirety.

### Introduction

A laser may be used to pattern electrically conductive films to produce regions of lower conductivity near regions of higher conductivity. Where such electrically conductive films comprise silver nanowires embedded in a polymer matrix and surrounded by polymer layers, we have discovered that increased radiation absorption by silver nanowires is dependent on the operating wavelength of the laser and the orientation of the silver nanowires relative to the polarization direction of the laser.

### Electrically Conductive Film

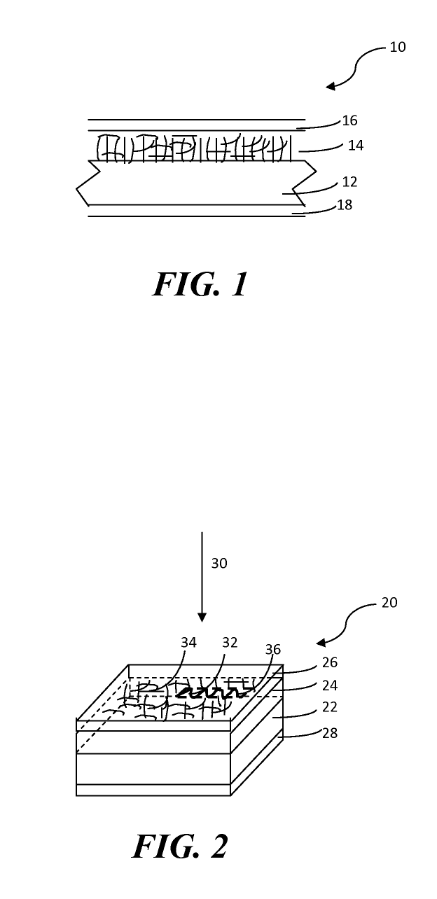

FIG. 1 shows an embodiment of an electrically conductive film 10. The electrically conductive film 10 may comprise a top coat layer 16, an electrically conductive layer 14, a substrate 12, and a hard coat layer 18. The top coat layer 16 may be disposed on the electrically conductive layer 14. The electrically conductive layer 14 may be disposed on the substrate 12. The substrate 12 may be disposed on the hard coat layer 18. In some embodiments, the substrate may comprise polyethylene terephthalate (PET). In some embodiments, an adhesive (not shown) may be used to bond the hard coat layer 18 to the substrate 12.

The electrically conductive layer may comprise a plurality of electrically conductive structures, such as electrically conductive microstructures or electrically conductive nanostructures. Microstructures and nanostructures are defined according to the length of their shortest dimensions. The shortest dimension of the nanostructure is sized between 1 nm and 100 nm. The shortest dimension of the microstructure is sized between 0.1 μm to 100 μm. Conductive nanostructures may include, for example, metal nanostructures. Non-limiting examples of electrically conductive nanostructures that may be incorporated into the electrically conductive layer include nanowires, nanotubes, metal meshes, graphenes, and oxides, such indium tin oxide. Such electrically conductive nanostructures may comprise metals, such as silver. For example, the electrically conductive nanostructures may be silver nanowires. Examples of transparent conductive films comprising silver nanowires and methods for preparing them are disclosed in US patent application publication 2012/0107600, entitled “TRANSPARENT CONDUCTIVE FILM COMPRISING CELLULOSE ESTERS,” which is hereby incorporated by reference in its entirety.

In some embodiments, the electrically conductive film may be optically transparent. In some embodiments, the top coat layer and the hard coat layer may comprise a polymer, such as cellulose acetate butyrate (CAB). In some embodiments, the top coat layer may comprise polysiloxane, such as SLIP-AYD® FS-444, which is available from Elementis Specialties. In some embodiments, the electrically conductive layer may be more flexible than the substrate, the hard coat layer, or the top coat layer. Accordingly, the substrate, the hard coat layer, and the top coat layer may each be more rigid than the electrically conductive layer. In some cases, the substrate, the hard coat layer, and the top coat layer may protect the electrically conductive layer.

### Laser Patterned Electrically Conductive Film

FIG. 2 shows an embodiment of a laser patterned electrically conductive film 20. The patterned electrically conductive film 20 may be a multi-layer structure that comprises a top coat layer 26, an electrically conductive layer 24, a substrate 22, and a hard coat layer 28. The top coat layer 26 may be disposed on the electrically conductive layer 24. The electrically conductive layer 24 may be disposed on the substrate 22. The substrate 22 may be disposed on the hard coat layer 28. In some embodiments, an adhesive (not shown) may be used to bond the hard coat layer 28 to the substrate 22.

The electrically conductive layer 24 may comprise a plurality of electrical conductive nanostructures, such as metal nanowires or silver nanowires. The electrical conductors may be electrically interconnected to impart conductivity to the electrically conductive layer 24 or the electrically conductive film 20 as a multi-layer structure comprising the electrically conductive layer 24. The electrically conductive film 20 may comprise a first region 32 exhibiting a first conductivity and a second region 34 exhibiting a second conductivity. A region may be defined as an area on the surface of the electrically conductive film 20 that may extend into the layers of the electrically conductive film 20 substantially normal to the surface of the electrically conductive film 20 or the top coat layer 26. For example, a region as an area on the surface of the electrically conductive film 20 may extend into the layers of the electrically conductive film 20 substantially normal to the surface of the electrically conductive film 20 when the area is within 10 degrees of a vector normal to the surface of the electrically conductive film 20 or the top coat layer 26.

The first region 32 may comprise a first pattern 36. The first pattern 36 may be formed by exposing the first region 32 to a laser beam 30 from a laser. After exposing the first region 32 of the electrically conductive film 20 to the laser beam 30, the nanowires in the first region 32 may absorb radiation from the laser beam 30, such that the first region 32 of the electrically conductive film 20 may exhibit a third conductivity that is less than the second conductivity. Without wishing to be bound by theory, it is believed that the radiation absorption by the nanowires may cause the nanowires to separate into smaller nanostructures, thus disrupting the electrical interconnection among nanowires and causing a decrease in conductivity in the region. In some embodiments, the nanostructures may be spaced apart from each other, such that they no longer electrically connect or communicate.

In some embodiments where the first region 32 exhibits a first conductivity less than the second conductivity of the second region 34, the average length of the plurality of electrically conductive nanostructures in the first region 32 may be less than the average length of the plurality of electrically conductive nanostructures in the second region 34. In some embodiments, the lengths of the plurality of electrically conductive nanostructures in the second region 34 may be between about 1 to 100 micrometers. In some embodiments, the lengths of the plurality of electrically conductive nanostructures in the second region 34 may be between about 5 to 30 micrometers. In some embodiments, some of the plurality of electrically conductive nanostructures in the first region 32 may comprise lengths between about 5 to 30 micrometers, between about 5 to 500 nanometers, between about 1 to 5 micrometers, or between about 1 to 10 micrometers. For example, the first region may comprise silver nanowires having lengths between about 5 to 30 micrometers, silver nanospheres having lengths between about 5 to 500 nanometers, and silver nanorods between about 1 to 10 micrometers or between about 1 to 5 micrometers.

In some embodiments where the first region 32 exhibits a first conductivity less than the second conductivity of the second region 34, the average aspect ratio of the plurality of electrically conductive nanostructures in the first region 32 may be less than the average aspect ratio of the plurality of electrically conductive nanostructures in the second region. For the purposes of this application, the average aspect ratio of a plurality of electrical conductive nanostructures is the average of the ratio of the length of each electrical conductive nanostructure and its diameter. In some embodiments, prior to exposing the first region of the conductive film to the laser beam, the first region may comprise a preexisting number of electrically conductive nanostructures, and after exposing the first region to the laser beam, the first region may comprise a consequent number of electrically conductive nanostructures that is greater than its preexisting number of electrically conductive nanostructures. In some embodiments, prior to exposing the first region of the electrically conductive film to the laser beam, the first region may comprise a first preexisting number of electrically conductive nanostructures and the second region may comprise a second preexisting number of electrically conductive nanostructures, the first preexisting number and the second preexisting number being substantially identical. For the purposes of this application, “substantially identical” between quantified characteristics means within a 10% difference between a first quantified characteristic of the highest value and a second quantified characteristic of the lowest value. For example, the first preexisting number and the second preexisting number are substantially identical when they are within 10% of each other. In other examples when there is a first preexisting number, a second preexisting number, and a third preexisting number, the first preexisting number, the second preexisting number, and the third preexisting number are substantially identical if the differences between the preexisting numbers of the lowest and highest values are within 10% of each other. In some embodiments, after exposing the first region to the laser beam, the first region may exhibit a consequent number of electrically conductive nanostructures that is greater than the number of electrically conductive nanostructures in the second region.

In some embodiments, the top coat layer 26 may form the top surface of the electrically conductive film 20. Radiation may be absorbed by the underlying electrically conductive layer 24 through the top coat layer 26. A suitable laser operated under suitable parameters may be used to expose the nanowires in a first region to radiation to decrease the conductivity in first region without damaging the top coat layer 26, substrate 22, or hard coat layer 28 and without rendering the pattern 36 visible to the unaided eye.

In some embodiments, prior to exposing the first region of the electrically conductive film to the laser beam, the first region may exhibit a first preexisting set of optical properties and the second region may exhibit a second preexisting set of optical properties, and after exposing the first region to the laser beam, the first region may exhibit a first consequent set of optical properties and the second region may exhibit a second consequent set of optical properties. In some embodiments, the first consequent set of optical properties is substantially identical to the second consequent set of optical properties. In some embodiments, the first preexisting set of optical properties is substantially identical to the first consequent set of optical properties. In some embodiments, the first preexisting set of optical properties is substantially identical to the second preexisting set of optical properties. In some embodiments, the first preexisting set of optical properties is substantially identical to the second consequent set of optical properties. In some embodiments, the first preexisting set of optical properties is substantially identical to the second preexisting set of optical properties and the second consequent set of optical properties. For the purpose of this application, the term “substantially identical” indicates differences that are not discernible to the unaided eye. In some embodiments, “substantially identical” may mean that the difference between two sets of optical properties that have either the highest or lowest quantified value is within 10% of each other.

Such a first preexisting set of optical properties may, for example, comprise one or more of a first preexisting total light transmission, a first preexisting haze, a first preexisting reflectance value, a first preexisting spectral value, a first preexisting L* value, a first preexisting a* value, or a first preexisting b* value. Such a second preexisting set of optical properties may, for example, comprise one or more of a second preexisting total light transmission, a second preexisting haze, a second preexisting reflectance value, a second preexisting spectral value, a second preexisting L* value, a second preexisting a* value, or a second preexisting b* value. Such a first consequent set of optical properties may, for example, comprise one or more of a first consequent total light transmission, a first consequent haze, a first consequent reflectance value, a first consequent spectral value, a first consequent L* value, a first consequent a* value, or a first consequent b* value. Such a second consequent set of optical properties may, for example, comprise one or more of a second consequent total light transmission, a second consequent haze, a second consequent reflectance value, a second consequent spectral value, a second consequent L* value, a second consequent a* value, or a second consequent b* value. For the purpose of this application, “substantially similar optical appearance” indicates that differences in total light transmission, haze, L*, a*, and b* are not discernible to the unaided eye. The L* value, a* value, and b* value are part of the Commission Internationale de l'Eclairage (CIE) system of describing the color of an object. For example, the preexisting set of optical properties may differ from the consequent set of optical properties by less than 1%.

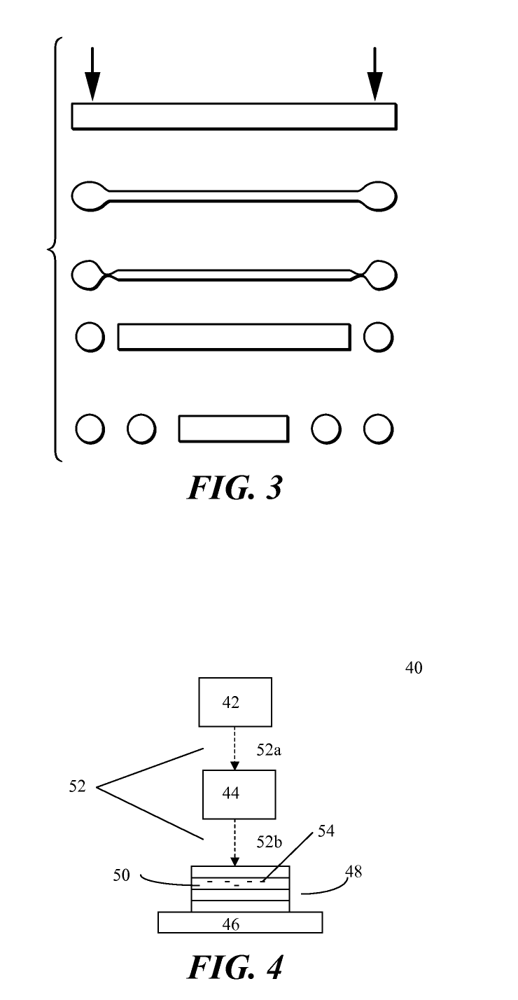

FIG. 3 shows an embodiment of a process in which a nanowire is separated into nanostructures of smaller lengths. When subjected to radiation, the ends of the nanowire may separate from the body of the nanowire in a separation process in which the point of attachment between the ends of the nanowire and the body of the nanowire narrows to the point of separation of the ends of the nanowire from the nanowire body. The separation process may continue with the remaining nanowire. For example, the ends of the remaining nanowire may separate from the body of the remaining nanowire in a separation process in which the point of attachment between the ends of the nanowire and the body of the remaining nanowire narrows to the point of separation of the ends of the nanowire from the body of the remaining nanowire. In some embodiments, the nanowires are separated by being melted into nanostructures. In some embodiments, the separation process may continue after the electrically conductive film is exposed to radiation. In some embodiments, the nanowires are separated into collinear nano structures.

### Laser

The laser used in patterning may be a polarized ultraviolet laser emitting light at an ultraviolet wavelength and pulse duration on the order of less than or equal to about 10 picoseconds. Such a laser may render desired regions of the electrically conductive film electrically isolating with minimal damage to the polymer matrix in which the electrically conductive nanostructures are embedded and polymer layers over lying and underlying the electrically conductive layer. Such a laser may form the desired electrical pattern that is invisible to the unaided eye. For the purposes of this application, “minimal damage” may be interpreted to mean damage that does not substantially affect the function of the indicated portion of the electrically conductive film. In some cases, damage is minimized to the point of not being discernible by the unaided eye.

The laser may be any suitable laser, for example, an excimer laser, a solid-state laser, such as a diode-pumped solid state laser, a semiconductor laser, a gas laser, a chemical laser, a fiber laser, a dye laser, or a free electron laser. The pulse duration of the laser may be on the order of nanoseconds or femtoseconds. The electrically conductive film or the electrically conductive nanostructures may exhibit absorption across a wide spectrum of wavelengths and may accommodate a variety of lasers at different wavelengths. The laser may be an ultraviolet, visible, or an infrared laser. The laser may be a continuous wave laser or a pulsed laser. The laser may be operated at a selected scan speed, repetition rate, pulse energy, and laser power.

Where nanowires intersect, there may be an increase in radiation absorption in nanowires near the intersection. In some cases, such increase in absorption may be attributed to an increase in electric field or optical intensity near the intersection. Additionally, surface plasmon resonances may be more readily excited at the ends of the nanowires than the body of the nanowire. It is believed that the combination of such characteristics of nanowires and laser process conditions may affect the amount and morphology of damage to the polymeric material surrounding the nanowires.

### Laser Wavelength

In some embodiments, the laser used in patterning may be an ultraviolet (UV) laser. UV lasers may emit light at wavelengths of up to about 450 nm. In some embodiments, an electrically conductive film is patterned with a laser emitting light at a wavelength of about 355 nm. Without wishing to be bound by theory, based on the Mie theory of light scattering, it is believed that Silver nanowires of 40 nm diameter and infinite length surrounded by cellulose acetate butyrate may have maximum radiation absorption at a wavelength of about 350-400 nm. In some embodiments, the laser used in patterning may be an infrared (IR) laser. IR lasers may emit light at wavelengths between about 650 nm to about 1 mm. In some embodiments, the laser used in patterning may be a visible laser. Visible lasers may emit light at wavelengths of about 350 nm to about 750 nm.

### Polarization of Laser

In some embodiments, the laser used in patterning may be polarized. Radiation, such as light, that exhibits different properties in different directions that are at right angles to the line of propagation is said to be polarized. Polarization of light may be described by specifying the orientation of the wave's electric field at a point in space over one period of oscillation. The direction of polarization may be described as the direction in which the wave oscillates. A laser beam may have a linear, circular, random, or radial polarization state. In linear polarization, the electric field oscillates in a certain stable direction perpendicular to the line of propagation of the laser beam. The laser beam may have a horizontal linear polarization state or a vertical linear polarization state. In circular polarization, the electric field may rotate as the wave travels. The laser beam may have a left circular polarization state or a right circular polarization state. In radial polarization, the electric field may have both a longitudinal and transverse component. In such cases, the electric field vector points toward the center of the beam at every position in the beam.

Increased radiation absorption (e.g. maximized radiation absorption) by electrically conductive nanostructures may depend on the orientation of the pattern relative to the orientation of the polarization direction. In some embodiments, where a UV laser beam has a linear polarization direction in a first direction, less power per unit area is required to isolate a pattern aligned substantially in the first direction than a pattern aligned in a second direction that is substantially perpendicular to the first direction. For example, a random network of silver nanowires with uniform orientation distribution may be in the XY plane, and a linearly polarized UV laser beam at 355 nm may be incident normal to the XY plane (i.e. propagating in the Z axis) with polarization aligned with the X direction. In such cases, less power per unit area may be required to isolate a pattern aligned in the X direction than a pattern aligned in the Y direction, which is perpendicular to the X and Z directions. Without wishing to be bound by theory, it is believed that a surface plasmon resonance (SPR) may be generated preferentially in wires primarily aligned in the Y axis. The SPR may cause increased energy absorption in the wires oriented in the Y axis, which may tend to heat up and melt with less energy relative to wires that are not aligned with a significant component in the Y-axis. Mathematically, absorption at this wavelength has a component from the SPR which is related to the sine of the angle between the wire orientation and the direction of polarization such that when the angle is zero the SPR is zero, but when the angle is 90 degrees, the SPR is at its maximum. Through this mechanism, when the UV laser is polarized in the X direction, a line patterned in the X direction may require lower energy relative to a line patterned in the Y direction. The X direction line may have wires oriented in the Y direction, which may be situated across the isolation path, preferentially melted. Conversely, the Y direction line may tend to melt wires parallel to the isolation path, but may leave the wires that span across the gap in the X direction, which may leave an electrical path between the two regions so electrical current can flow between the two regions, and thus, require more energy to become isolated. Increased radiation absorption (e.g. maximized radiation absorption) by electrically conductive nanostructures may depend on the orientation of the nanostructures relative to the polarization direction of the radiation source and the wavelength of the radiation source. In some embodiments, electrically conductive nanostructures aligned parallel with the polarization direction of a laser beam may exhibit increased radiation absorption from lasers outputting wavelengths longer than about 400 nm or longer than about 500 nm, such as an infrared or visible laser. An infrared laser has an output wavelength in the infrared region of the electromagnetic spectrum, that is, wavelength in the range from about 750 nm to about 1 mm. A visible laser has an output wavelength in the visible region of the electromagnetic spectrum, that is, wavelength in the range from about 400 nm to about 750 nm. In some cases, electrically conductive nanostructures aligned parallel with the polarization direction of an infrared laser beam may exhibit increased radiation absorption at approximately 1064 nm. In such cases, electrically conductive nanostructures aligned parallel with the polarization direction of a visible laser may exhibit increased radiation absorption at approximately 532 nm. In some embodiments, electrically conductive nanostructures aligned perpendicular to the polarization direction of a laser beam may exhibit increased radiation absorption from an ultraviolet laser. An ultraviolet laser has an output wavelength in the ultraviolet region of the electromagnetic spectrum, that is, wavelength in the range from about 10 nm to about 400 nm. In such cases, electrically conductive nanostructures aligned perpendicular to the polarization direction of an ultraviolet laser may exhibit increased radiation absorption at approximately 355 nm.

In some embodiments, the electrically conductive nanostructures in the transparent conductive film may be a plurality silver nanowires. For silver nanowires, the SPR peak in absorption when light is polarized perpendicular to the wires occurs at between 350 to 400 nm. In this case, the transverse electric (TE) component of absorption dominates at wavelengths shorter than about 500 nm and above 500 nm the transverse magnetic (TM) absorption—where the electric field is polarized parallel to the wire—dominates. Total absorption for a randomly aligned network will be the average of TE and TM absorption. Thus, for silver nanowires, the threshold wavelength where the dominating absorption polarization changes from TE to TM is about 500 nm. In other metallic nanowire films, the SPR peak may be at shorter or longer wavelengths. For example, a random network of gold nanowires may have the SPR peak in the visible wavelength range and the threshold wavelength where the dominating absorption polarization changes from TE to TM may be in the range of 600-1000 nm or 500 to 1500 nm, and so on.

In some embodiments, where an infrared or visible laser beam has a linear polarization direction in a first direction, more power per unit area is required to isolate a pattern aligned substantially in the first direction than a pattern aligned in a second direction that is substantially perpendicular to the first direction. For example, a random network of metallic nanowires with uniform orientation distribution may be in the XY plane, and a linearly polarized infrared or visible laser beam may be incident normal to the XY plane (i.e. propagating in the Z axis) with polarization aligned with the X direction. In such cases, less power per unit area may be required to isolate a pattern aligned in the Y direction than a pattern aligned in the X direction, which is perpendicular to the Y and Z directions. Without wishing to be bound by theory, it is believed that wires primarily aligned in the X axis have increased absorption. The increased energy absorption in the wires oriented in the X axis may tend to heat up and melt with less energy relative to wires that are not aligned with a significant component in the X-axis. Mathematically, absorption at this wavelength has a component related to polarization which is related to the cosine of the angle between the wire orientation and the direction of polarization such that when the angle is zero the absorption is maximum, but when the angle is 90 degrees, the absorption is at its minimum or zero. Through this mechanism, when the IR or visible laser is polarized in the X direction, a line patterned in the Y direction may require lower energy relative to a line patterned in the X direction. The Y direction line may have wires oriented in the X direction, which may be situated across the isolation path, preferentially melted. Conversely, the X direction line may tend to melt wires parallel to the isolation path, but may leave the wires that span across the gap in the Y direction, which may leave an electrical path between the two regions so electrical current can flow between the two regions, and thus, require more energy to become isolated.

In some embodiments, an electrically conductive film may comprise randomly oriented electrically conductive nanostructures some of which may align parallel with the direction of polarization of a laser beam, some of which may align perpendicular with the direction of polarization of the laser beam, and others which may have a component that is parallel and a component that perpendicular to the direction of polarization. In some cases, an infrared or visible laser may ablate electrically conductive nanostructures aligned parallel with the direction of polarization of a laser beam to attain electrical isolation while other oriented electrically conductive nanostructures remain un-ablated for minimal change in optical properties, which may make the pattern more invisible to the unaided eye. In some cases, an ultraviolet laser may ablate electrically conductive nanostructures aligned perpendicular with the direction of polarization of a laser beam to attain electrical isolation while other oriented electrically conductive nanostructures remain un-ablated for minimal change in optical properties, which may make the pattern more invisible to the unaided eye.

FIG. 4 shows a side view of an embodiment of a laser system. The laser system 40 may comprise a laser 42, optics 44, and a mount 46 for supporting an electrically conductive film 48 comprising an electrically conductive layer 50 that may comprise electrically conductive nanostructures, such as silver nanowires 54. In system 40, the laser 42 may be configured to generate a polarized laser beam 52 having a first portion 52a and a second portion 52b. The polarized laser beam 52 first portion 52a may be received and modified by optics 44. Optics 44 may output a modified version of the polarized laser beam firm portion 52a as polarized laser beam second portion 52b. Second portion 52b may be focused, redirected, filtered, polarized, and/or otherwise modified with respect to first portion 52a by optics 44. Optics 44 may direct the polarized laser beam 52 onto the electrically conductive film 48. The polarized laser beam 52 may be configured to ablate silver nanowire(s). As shown, the polarized laser beam 52 may be directed at the electrically conductive film 48 in a direction that is substantially perpendicular to the surface of the electrically conductive film 48. The polarization direction of the laser beam may be perpendicular to the line of propagation of the laser beam. For the purposes of this application, “substantially perpendicular” may be interpreted to mean within 10° of a perpendicular. In some embodiments, the laser system may comprise a half wave plate that may be adjusted to rotate the polarization direction or a quarter wave plate may be used to convert linearly polarized light to circularly polarized and vice-versa. In some embodiments, the rotation of polarization may be coordinated by the system such that certain lines may be patterned with one polarization and another set of lines may be patterned with a second or third polarization angle.

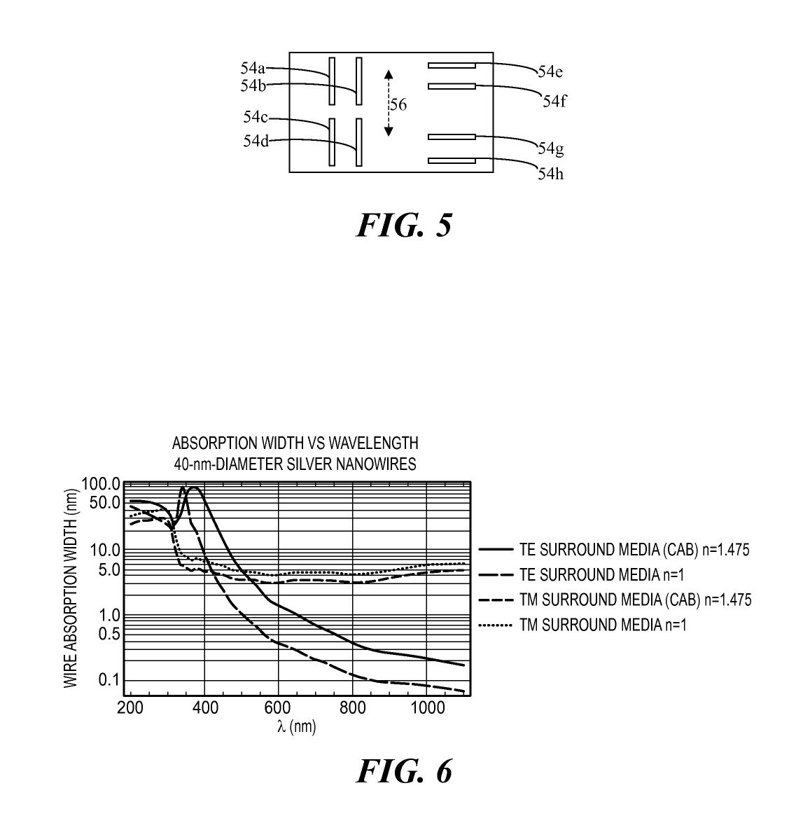

FIG. 5 shows a top view of an embodiment of an electrically conductive film that may be subjected to the laser system of FIG. 4. A polarized laser beam 52 may be directed onto the silver nanowires 54a, 54b, 54c, 54d, 54e, 54f, 54g, 54h . . . . A portion or entirety of each of the nanowires 54a, 54b, 54c, 54d, 54e, 54f, 54g, 54h . . . may be within the region subjected to irradiation. In some embodiments, nanowire(s) 54a, 54b, 54c, 54d may be aligned substantially parallel to an axis, such as an axis 56 shown in FIG. 5. In some embodiments, polarized laser beam 52 may have a polarization direction that may be aligned substantially parallel to the axis 56. In some embodiments, polarized laser beam 52 may have a polarization direction that may be aligned substantially parallel to a lengthwise or longitudinal axis of the at least one nanowire 54a, 54b, 54c, 54d. For the purposes of this application, two objects are “substantially parallel” if the first object is parallel to the second object within 10°. In some embodiments, nanowire(s) 54e, 54f, 54g, 54h may be aligned substantially perpendicular to the axis 56. In some embodiments, polarized laser beam 52 may have a polarization direction that may be aligned substantially perpendicular to a lengthwise or longitudinal axis of the at least one nanowire 54e, 54f, 54g, 54h. If an infrared or visible laser is used, nanowires 54a, 54b, 54c, 54d may absorb more radiation and may be more likely to be ablated than nanowires 54e, 54f, 54g, 54h. If an ultraviolet laser is used, nanowires 54e, 54f, 54g, 54h may absorb more radiation and may be more likely to be ablated than nanowires 54a, 54b, 54c, 54d.

In some embodiments, electrically conductive nanostructures in an electrically conductive film may be aligned during and after deposition of electrically conductive nanostructures onto a substrate. Any alignment techniques may be used, such as self-assembled monolayer film alignment, Langmuir-Blodgett film alignment, Gibbs monolayer film alignment, fluidic flow (i.e. flow induced shear force such as slot or curtain coating), mechanical shear force (e.g. using a gravure coater), mechanical stretching, electrical field, magnetic field, or other techniques.

In some embodiments, an electrically conductive film may comprise at least one region comprising a substantial number of electrically conductive nanostructures that are aligned substantially parallel to the polarization direction of a laser beam and at least one region comprising a substantial number of electrically conductive nanostructures that are aligned substantially perpendicular to the polarization of the laser beam. In some cases, the laser beam may be directed at the regions comprising electrically conductive nanostructures that are aligned substantially parallel to the polarization direction. In some embodiments, an electrically conductive film may comprise a substantial number of electrically conductive nanostructures that are aligned substantially perpendicular to the polarization direction of a laser beam. In some embodiments, an electrically conductive film may comprise a substantial number of electrically conductive nanostructures that are aligned substantially parallel to the polarization direction of a laser beam. In some cases, the laser beam may be directed at the regions comprising electrically conductive nanostructures that are aligned substantially perpendicular to the polarization direction. In some embodiments, an electrically conductive film may comprise a substantial number of electrically conductive nanostructures that are aligned substantially parallel to the polarization direction.

For the purposes of this application, a “substantial number” may be interpreted to mean at least 50%, 55%, 60%, 65%, 70%, 75%, 80%, 85%, 90%, 95%, 99%, etc.

### Laser Pulse Duration

Pulsed lasers may be used to pattern an electrically conductive film. In some cases, the use of a continuous wave laser to pattern an electrically conductive film comprising silver nanowires embedded in a polymer matrix and surrounded by overlying and underlying polymer layers may cause damage to the polymeric areas before electrical isolation occurs. In such cases, a continuous wave laser may supply energy in a gradual manner, such that heat may be absorbed into the bulk of the material (e.g. polymer matrix and polymer layers) without attaining a sufficiently high temperature at a particular point. Pulsed laser may be able to ablate a small volume of material, such as silver nanowires, by heating in a very short time. Pulsed laser may produce pulses of maximum energy. Since pulse energy is equal to the average power divided by the repetition rate, pulses of maximum energy may be accomplished by lowering the rate of pulses so more energy may be built up in between pulses. In some cases, high energy pulses may cause chemical bonds to be broken for polymers while photons are absorbed and converted into heat for metals. In some embodiments, such pulses may be ultraviolet.

In some embodiments, an ultrashort pulse laser may be used to pattern an electrically conductive film. An ultrashort pulse laser may emit ultrashort pulses of light, generally on the order of femtoseconds, picoseconds (e.g. ten picoseconds), or attoseconds. In some embodiments, the pulse duration may be on the order of microseconds or nanoseconds. The pulse energy may be in the milli-, micro-, or nanojoule per pulse. The peak power, which is pulse energy divided by pulse duration, may be in the kilowatt range while average power maybe in Watts to tens of Watts.

In some embodiments, the pulse duration may be short, such as, for example, less than about 100 nanoseconds. In some embodiments, the pulse duration may be ultra-short, such as, for example, less than about 1 nanosecond. In some embodiments, the ultra-short pulse duration may be less than about 100 picoseconds. In some embodiments, the ultra-short pulse duration may be less than about 15 picoseconds. In some embodiments, the ultra-short pulse duration may be between about 10 to about 12 picoseconds. In some embodiments, the ultra-short pulse duration may be about 12 picoseconds. In some embodiments, the ultra-short pulse duration may be less than about 12 picoseconds. In some embodiments, the ultra-short pulse duration may be less than about 10 picoseconds. In some cases, picosecond or nanosecond pulse durations may be conducive to nanowires absorbing heat at the ends or intersections of nanowires. In such cases, the picosecond pulse duration may not be sufficient for heat to diffuse along the nanowires and cause melting or vaporization. In some cases, the nanowire may be separated into nanospheres or nanorods that are collinear with the original nanowire. In some cases where lasers having pulse durations greater than the about 10 picoseconds, the nanowire may heat up and there may be more time to melt the surrounding polymer. In such cases, the top coat layer may be delaminated.

### EXEMPLARY EMBODIMENTS

U.S. Provisional Application No. 61/931,831, filed Jan. 27, 2014, entitled “POLARIZED LASER FOR PATTERNING OF SILVER NANOWIRE TRANSPARENT CONDUCTIVE FILMS,” which is hereby incorporated by reference in its entirety, disclosed the following 63 non-limiting exemplary embodiments:

A. A method comprising:

providing an electrically conductive film comprising a first set of electrically conductive nanostructures in a first region that exhibits a first conductivity and a second set of electrically conductive nanostructures in a second region that exhibits a second conductivity, and

irradiating the first region of the electrically conductive film with a polarized laser beam having an ultraviolet light frequency at a pulse duration less than 100 nanoseconds,

wherein, after irradiating the first region of the electrically conductive film, the first region exhibits a third conductivity that is less than the second conductivity.

B. The method of embodiment A, wherein the polarized laser beam has a polarization direction, and wherein at least one of the electrically conductive nanostructures in the first set of electrically conductive nanostructures in the first region has an orientation direction that is aligned substantially perpendicular to the polarization direction.
C. The method of either of embodiments A and B, wherein the polarized light beam has an ultraviolet light frequency of about 355 nm.
D. The method of any of embodiments A-C, wherein the pulse duration is less than about 1 nanosecond.
E. The method of any of embodiments A-D, wherein the pulse duration is less than about 100 picoseconds.
F. The method of any of embodiments A-E, wherein the pulse duration is less than about 15 picoseconds.
G. The method of any of embodiments A-F, wherein the pulse duration is less than about 10 picoseconds.
H. The method of any of embodiments A-G,

wherein the electrically conductive film comprises a top coat layer disposed on an electrically conductive layer that comprises the first set of electrically conductive nanostructures and the second set of electrically conductive nanostructures, and

wherein, after irradiating the first region of the electrically conductive film, the top coat layer exhibits minimal damage.

J. The method of embodiment H,

wherein the electrically conductive film comprises a substrate, the electrically conductive layer being disposed on the substrate, and

wherein, after irradiating the first region of the electrically conductive film, the substrate exhibits minimal damage.

K. The method of any of embodiments J,

wherein the electrically conductive film comprises a hard coat layer, the substrate being disposed on the hard coat layer, and

wherein, after irradiating the first region of the electrically conductive film, the hard coat layer exhibits minimal damage.

L. The method of any of embodiments H-K, wherein the top coat layer comprises a polymer.
M. The method of any of embodiments H-L, wherein the electrically conductive layer comprises a polymer matrix, the first set of electrically conductive nanostructures and the second set of electrically conductive nanostructures being embedded in the polymer matrix.
N. The method of any of embodiments J-L, wherein the substrate comprises a polymer.
P. The method of any of embodiments K-L, wherein the hard coat layer comprises a polymer.
Q. The method of any of embodiments A-P, wherein the first set of electrically conductive nanostructures and the second set of electrically conductive nanostructures comprise silver nanowires.
R. The method of embodiment Q, wherein the silver nanowires has an average diameter, the average diameter being about 10-40 nm.
S. A method comprising:

providing an electrically conductive film comprising a first set of electrically conductive nanostructures in a first region that exhibits a first conductivity and a second set of electrically conductive nanostructures in a second region that exhibits a second conductivity, and

irradiating the first region of the electrically conductive film with a polarized laser beam having a polarization direction, wherein at least one of the electrically conductive nanostructures in the first set of electrically conductive nanostructures in the first region has an orientation direction that is aligned substantially perpendicular to the polarization direction,

wherein, after irradiating the first region of the electrically conductive film, the first region exhibits a third conductivity that is less than the second conductivity.

T. The method of embodiment S, wherein the polarized laser beam has an ultraviolet light frequency.
U. The method of either of embodiments S or T, wherein the polarized laser beam has an ultraviolet light frequency of about 355 nm.
V. The method of any of embodiments S-U, wherein the first region of the electrically conductive film is irradiated with the polarized laser beam at a short pulse duration.
W. The method of any of embodiments S-V, wherein the first region of the electrically conductive film is irradiated with the polarized laser beam at an ultra-short pulse duration.
X. The method of any of embodiments S-V, wherein the first region of the electrically conductive film is irradiated with the polarized beam at a pulse duration of less than about 100 nanoseconds.
Y. The method of any of embodiments S-X, wherein the first region of the electrically conductive film is irradiated with the polarized beam at a pulse duration of less than about 1 nanosecond.
Z. The method of any of embodiments S-Y, wherein the first region of the electrically conductive film is irradiated with the polarized beam at a pulse duration of less than about 100 picoseconds.
AA. The method of any of embodiments S-Z, wherein the first region of the electrically conductive film is irradiated with the polarized beam at a pulse duration of less than about 15 picoseconds.
AB. The method of any of embodiments S-AA,

wherein the electrically conductive film comprises a top coat layer disposed on an electrically conductive layer that comprises the first set of electrically conductive nanostructures and the second set of electrically conductive nanostructures, and

wherein, after irradiating the first region of the electrically conductive film, the top coat layer exhibits minimal damage.

AC. The method of embodiment AB,

wherein the electrically conductive film comprises a substrate, the electrically conductive layer being disposed on the substrate, and

wherein, after irradiating the first region of the electrically conductive film, the substrate exhibits minimal damage.

AD. The method of embodiment AC,

wherein the electrically conductive film comprises a hard coat layer, the substrate being disposed on the hard coat layer, and

wherein, after irradiating the first region of the electrically conductive film, the hard coat layer exhibits minimal damage.

AE. The method of any of embodiments AB-AD,

wherein, after irradiating the first region of the electrically conductive film, the electrically conductive layer exhibits minimal damage.

AF. The method of any of embodiments AB-AE, wherein the top coat layer comprises a polymer.
AG. The method of any of embodiments AB-AF, wherein the electrically conductive layer comprises a polymer matrix, the first set of electrically conductive nanostructures and the second set of electrically conductive nanostructures being embedded in the polymer matrix.
AH. The method of any of embodiments AC-AG, wherein the substrate comprises a polymer.
AJ. The method of any of embodiments AD-AH, wherein the hard coat layer comprises a polymer.
AK. The method of any of embodiments S-AJ, wherein the first set of electrically conductive nanostructures and the second set of electrically conductive nanostructures comprise silver nanowires.
AL. The method of embodiment AK, wherein the silver nanowires has an average diameter, the average diameter being about 20-40 nm.
AM. A method comprising:

providing an electrically conductive film comprising a first set of electrically conductive nanostructures in a first region that exhibits a first conductivity and a second set of electrically conductive nanostructures in a second region that exhibits a second conductivity, and

irradiating the first region of the electrically conductive film with a polarized laser beam having a polarization direction, wherein at least one of the electrically conductive nanostructures in the first set of electrically conductive nanostructures in the first region has an orientation direction that is aligned substantially parallel to the polarization direction,

wherein, after irradiating the first region of the electrically conductive film, the first region exhibits a third conductivity that is less than the second conductivity.

AN. The method of embodiment AM, wherein the polarized laser beam has a visible or infrared light frequency.
AP. The method of either of embodiments AM or AN, wherein the polarized laser beam has a visible light frequency of about 532 nm.
AQ. The method of either of embodiments AM or AN, wherein the polarized laser beam has an infrared light frequency of about 1064 nm.
AR. The method of any of embodiments AM-AQ, wherein the first region of the electrically conductive film is irradiated with the polarized laser beam at a short pulse duration.
AS. The method of any of embodiments AM-AR, wherein the first region of the electrically conductive film is irradiated with the polarized laser beam at an ultra-short pulse duration.
AT. The method of any of embodiments AM-AR, wherein the first region of the electrically conductive film is irradiated with the polarized beam at a pulse duration of less than about 100 nanoseconds.
AU. The method of any of embodiments AM-AT, wherein the first region of the electrically conductive film is irradiated with the polarized beam at a pulse duration of less than about 1 nanosecond.
AV. The method of any of embodiments AM-AU, wherein the first region of the electrically conductive film is irradiated with the polarized beam at a pulse duration of less than about 100 picoseconds.
AW. The method of any of embodiments AM-AV, wherein the first region of the electrically conductive film is irradiated with the polarized beam at a pulse duration of less than about 15 picoseconds.
AX. The method of any of embodiments AM-AW,

wherein the electrically conductive film comprises a top coat layer disposed on an electrically conductive layer that comprises the first set of electrically conductive nanostructures and the second set of electrically conductive nanostructures, and

wherein, after irradiating the first region of the electrically conductive film, the top coat layer exhibits minimal damage.

AY. The method of embodiment AX,

wherein the electrically conductive film comprises a substrate, the electrically conductive layer being disposed on the substrate, and

wherein, after irradiating the first region of the electrically conductive film, the substrate exhibits minimal damage.

AZ. The method of embodiment AY,

wherein the electrically conductive film comprises a hard coat layer, the substrate being disposed on the hard coat layer, and

wherein, after irradiating the first region of the electrically conductive film, the hard coat layer exhibits minimal damage.

BA. The method of any of embodiments AX-AZ,

wherein, after irradiating the first region of the electrically conductive film, the electrically conductive layer exhibits minimal damage.

BB. The method of any of embodiments AX-BA, wherein the top coat layer comprises a polymer.
BC. The method of any of embodiments AX-BB, wherein the electrically conductive layer comprises a polymer matrix, the first set of electrically conductive nanostructures and the second set of electrically conductive nanostructures being embedded in the polymer matrix.
BD. The method of any of embodiments AY-BC, wherein the substrate comprises a polymer.
BE. The method of any of embodiments AZ-BD, wherein the hard coat layer comprises a polymer.
BF. The method of any of embodiments AM-BE, wherein the first set of electrically conductive nanostructures and the second set of electrically conductive nanostructures comprise silver nanowires.
BG. The method of embodiment BF, wherein the silver nanowires has an average diameter, the average diameter being about 20-40 nm.
BH. In a system comprising:

an electrically conductive film comprising a first set of electrically conductive nanostructures in a first region that exhibits a first conductivity and a second set of electrically conductive nanostructures in a second region that exhibits a second conductivity, and a polarized laser capable of emitting a polarized laser beam having a polarization direction,

a method of irradiating the first region of the electrically conductive film, the method comprising:

orienting the polarization direction of the polarized laser beam to be substantially perpendicular to at least one of the electrically conductive nanostructures in the first set of electrically conductive nanostructures in the first region, and

irradiating the at least one of the electrically conductive nanostructures with the polarized laser beam in the oriented polarization direction.

BI. In a system comprising:

an electrically conductive film comprising a first set of electrically conductive nanostructures in a first region that exhibits a first conductivity and a second set of electrically conductive nanostructures in a second region that exhibits a second conductivity, and a polarized laser capable of emitting a polarized laser beam having a polarization direction,

a method of irradiating the first region of the electrically conductive film, the method comprising:

orienting the polarization direction of the polarized laser beam to be substantially parallel to at least one of the electrically conductive nanostructures in the first set of electrically conductive nanostructures in the first region, and

irradiating the at least one of the electrically conductive nanostructures with the polarized laser beam in the oriented polarization direction.

BJ. A method comprising:

providing an electrically conductive film comprising a first set of electrically conductive nanostructures in a first region that exhibits a first conductivity and a second set of electrically conductive nanostructures in a second region that exhibits a second conductivity, and

irradiating the first region of the electrically conductive film with a polarized laser beam,

wherein, after irradiating the first region of the electrically conductive film, the first region exhibits a third conductivity that is less than the second conductivity.

BK. The method of embodiment BJ, wherein the laser beam is linearly, radially, or circularly polarized.
BL. A method comprising:

providing an electrically conductive film comprising a first set of electrically conductive nanostructures in a first region that exhibits a first conductivity and a second set of electrically conductive nanostructures in a second region that exhibits a second conductivity, and

irradiating the first region of the electrically conductive film with a polarized laser beam having a polarization direction to form a first pattern aligned with the polarization direction at a first laser power and a second pattern aligned substantially perpendicular to the polarization direction at a second laser power, the second laser power being less than the first laser power,

wherein, after irradiating the first region of the electrically conductive film, the first region exhibits a third conductivity that is less than the second conductivity.

BM. In a system comprising:

an electrically conductive film comprising a first set of electrically conductive nanostructures in a first region that exhibits a first conductivity and a second set of electrically conductive nanostructures in a second region that exhibits a second conductivity, and a polarized laser capable of emitting a polarized laser beam having a polarization direction,

a method of irradiating the first region of the electrically conductive film to form a first pattern, the method comprising:

orienting the polarization direction of the polarized laser beam, and

irradiating the first region to form the first pattern along the polarization direction.

BN. In a system comprising an electrically conductive film comprising a first set of electrically conductive nanostructures in a first region that exhibits a first conductivity, a second set of electrically conductive nanostructures in a second region that exhibits a second conductivity, a third set of electrically conductive nanostructures in a third region that exhibits a third conductivity, a polarized laser capable of emitting a polarized laser beam having a polarization direction to create a pattern comprising lines having a lengthwise direction, and a rotating wave plate to orient the polarization direction substantially parallel or substantially perpendicular to the lengthwise direction of lines in the pattern, a method of irradiating the electrically conductive film to form a pattern comprising lines having a lengthwise direction, the method comprising:

orienting the polarization direction of the polarized laser beam into a first polarization direction, and

irradiating the first region to form a first pattern comprising lines having a lengthwise direction aligned along the first polarization direction,

wherein the first polarization direction is either substantially parallel or substantially perpendicular to the lengthwise direction of the lines of a first pattern, and.

BP. The method of embodiment BN, further comprising

orienting the polarization direction of the polarized laser beam into a second polarization direction, and

irradiating the second region to form a second pattern comprising lines having a lengthwise direction aligned along the second polarization direction,

wherein the second polarization direction is either substantially parallel or substantially perpendicular to the lengthwise direction of the lines of the second pattern.

### EXAMPLES

### Methods

### Method of Producing Isolating Lines on a Film Sample

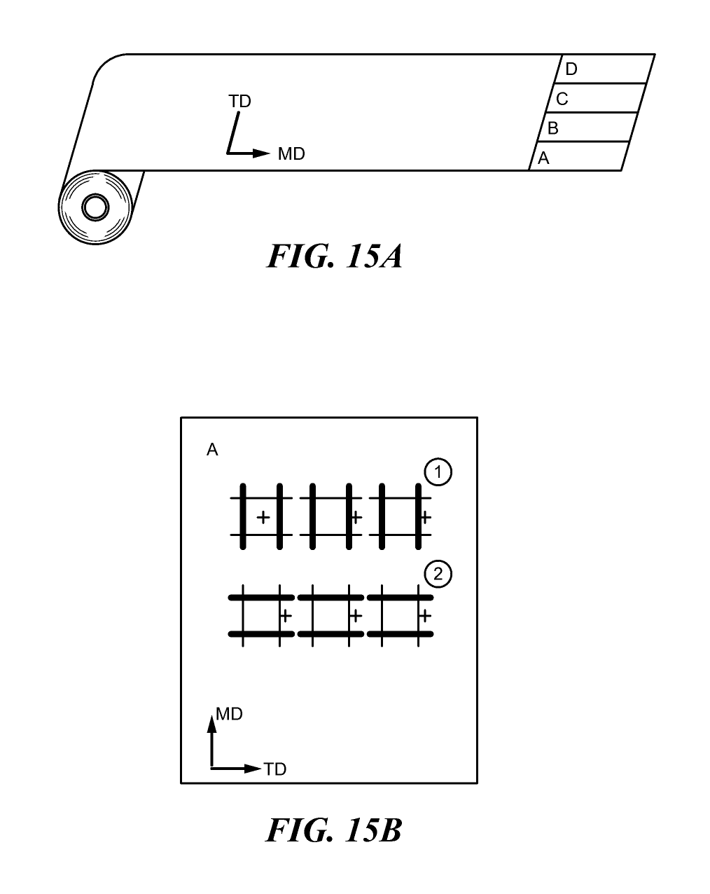

As shown in FIG. 15A, the machine direction (MD) and the transverse direction (TD) are directions relative to the surface of the film. The MD refers to the direction the film as it moves through a machine. The TD refers to the direction perpendicular to the MD. When placed in a laser system, the film is aligned with the MD in the direction into and out of the machine on a horizontal plane. A UV laser with a polarization direction along the MD is operated to irradiate the film to produce isolating “tic-tac-toe” patterns along several positions to create a row and column grid, as shown in FIG. 15B. The “+” symbols are used as visible markers with a high power and low scan speed—sufficient to damage the underlying substrate—to facilitate later isolation testing.

### Method for Determining Minimum Power to Produce TD Isolating Lines

Referring to row “1” or the top row in FIG. 15B, the test for determining the minimum power to produce TD isolating lines is illustrated. A pair of isolating lines in the MD is patterned around “+” patterns using the UV laser operated at relatively constant high power and low scan speed that is known to be isolating. The pair of MD lines is shown in thick, dark lines. The isolating MD lines are substantially parallel to one another. A pair of TD lines are patterned around a “+” pattern to intersect with the pair of MD lines to form a box around the “+” pattern. The pair of TD lines is shown in lines that are narrower than the pair of MD lines. The two TD lines are substantially parallel to one another and intersect perpendicularly with each of the MD lines. A multi-meter is used to determine whether the boxed region (including known isolating MD lines and unknown isolating TD lines) are isolating. The power used to form a pair of TD lines that intersects with a pair of MD lines to form a box is varied with each box, starting at a lower power until a power that renders the boxed region is isolating. This process is repeated on finer and finer increments of power until a sufficient amount of data is accumulated to give a high degree of confidence in the settings to isolate TD lines.

### Method for Determining Minimum Power to Produce MD Isolating Lines

Referring to row “2” or the bottom row in FIG. 15B, the test for determining the minimum power to produce MD isolating lines is illustrated. A pair of isolating lines in the TD is patterned around “+” patterns using the UV laser operated at relatively constant high power and low scan speed that is known to be isolating. The pair of TD lines is shown in thick, dark lines. The isolating TD lines are substantially parallel to one another. A pair of MD lines are patterned around a “+” pattern to intersect with the pair of TD lines to form a box around the “+” pattern. The pair of MD lines is shown in lines that are less thick and dark than the pair of TD lines. The two MD lines are substantially parallel to one another and intersect perpendicularly with each of the TD lines. A multi-meter is used to determine whether the boxed region (including known isolating TD lines and unknown isolating MD lines) is isolating. The power used to form a pair of MD lines that intersects with a pair of TD lines to form a box is varied with each box, starting at a lower power until a power that renders the boxed region is isolating.

### Example 1

Using the Mie theory of light scattering, the effective wire absorption width as a function of wavelength for 40 nm diameter silver nanowires was calculated and plotted as shown in FIG. 6. The highest peaks of the transverse electric (TE) curves and the lowest troughs of the transverse magnetic (TM) curves were positioned near wavelengths of approximately 355 nm. In other words, when the electric field is polarized perpendicular to the wire, the silver nanowires may exhibit increased absorption at around 350-400 nm, such as approximately at 355 nm. Without wishing to be bound by theory, it is believed that in the range of 350-400 nm, the wires may undergo a localized surface plasmon resonance (LSPR) when light (electric field) is polarized perpendicular to the wire, which may cause localized charge oscillations on the surface of the wire. Therefore, a laser operating at a wavelength of 355 nm was selected as the wavelength for high absorption by 40 nm diameter silver nanowires.

Using the same model for 40 nm wires, the absorption of the transverse magnetic was calculated to be higher than the absorption of transverse electric at above roughly 500 nm. Thus, for lasers with wavelengths longer than 500 nm, such as 532 and 1064 nm, the nanowires may exhibit increased absorption when light is polarized in a direction parallel with the long axis of the wire. For example, nanowires may exhibit increased absorption from a linearly polarized 1064 nm laser when oriented parallel to the polarization direction of the laser.

### Example 2

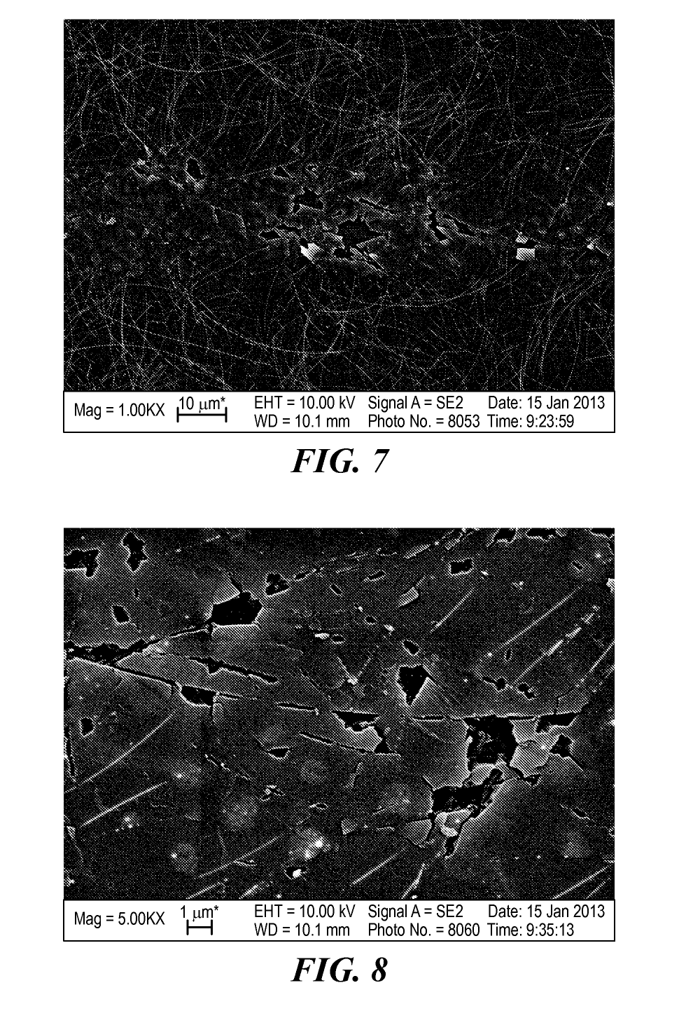

Samples of electrically conductive films comprising silver nanowires having an average diameter of between about 10 nm to about 40 nm or between about 20 nm to about 40 nm were provided. A randomly polarized infrared YAG fiber laser operating at a wavelength of 1064 nm and pulse duration of 100 ns was used. Other parameters for laser operation include a spot size of 30 μm, scan speed of 1000 mm/s, repetition rate of 67 kHz, and pulse energy of 24 μJ was used. Using such a laser operating at the conditions stated above, a sample of an electrically conductive film was irradiated and the threshold for electrical isolation (i.e. the lower limit at which electrical isolation begins to occur) was determined to be at a laser power of 8% of 20 W (i.e. 1.6 W). With all other operational parameters remaining the same, another sample of an electrically conductive film was irradiated at a laser power of 9% of 20 W (1.8 W), forming a laser patterned line on the electrically conductive film. FIGS. 7 and 8 show scanning electron microscope images of the electrically conductive film after laser irradiation using a laser power of 1.8 W at magnifications of 1000 times and 5000 times, respectively. FIGS. 7 and 8 show significant damage to the polymer around the nanowires along the laser patterned line.

### Example 3

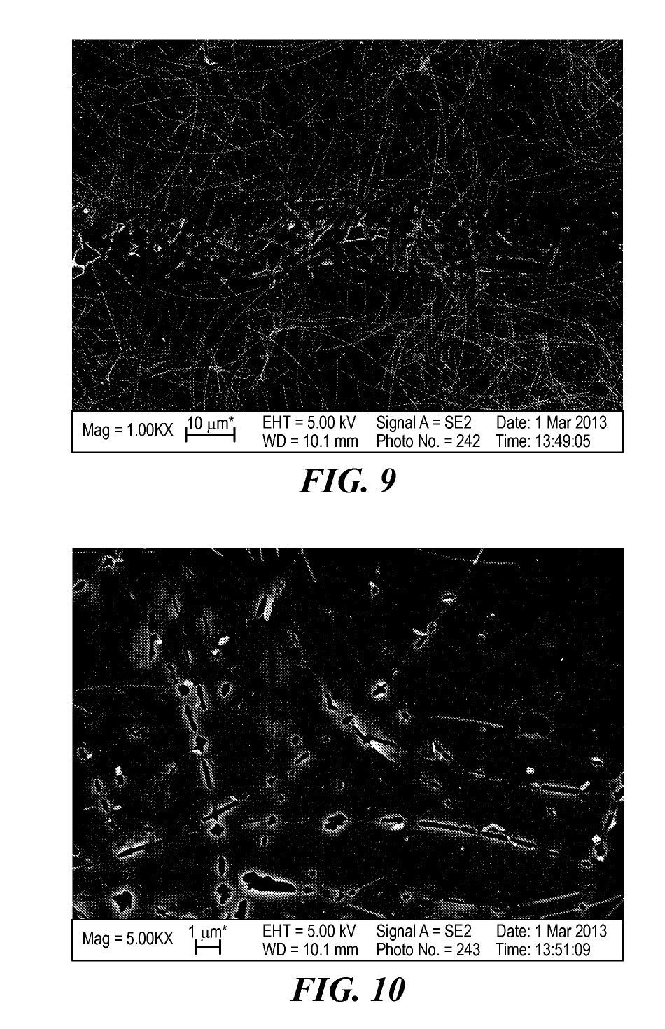

A sample of an electrically conductive film comprising silver nanowires having an average diameter of between about 10 to about 40 nm or between about 20 to about 40 nm was provided. A randomly polarized visible YAG fiber laser operating at a wavelength of 532 nm and pulse duration of 40 ns was used. Other parameters of laser operation include a spot size of 26 μm, scan speed of 1000 mm/s, repetition rate of 100 kHz, and pulse energy of 10.0 μJ. Using such a laser operating at the conditions stated above, a sample of an electrically conductive film was irradiated along a line, and the threshold for electrical isolation (i.e. the lower limit at which electrical isolation begins to occur) was determined to be at a laser power of 1.0 W. FIGS. 9 and 10 show scanning electron microscope images of an electrically conductive film after laser irradiation at magnifications of 1000 times and 5000 times, respectively. FIGS. 9 and 10 show somewhat less damage to the polymer around the nanowires along the laser patterned line than FIGS. 7 and 8.

### Example 4

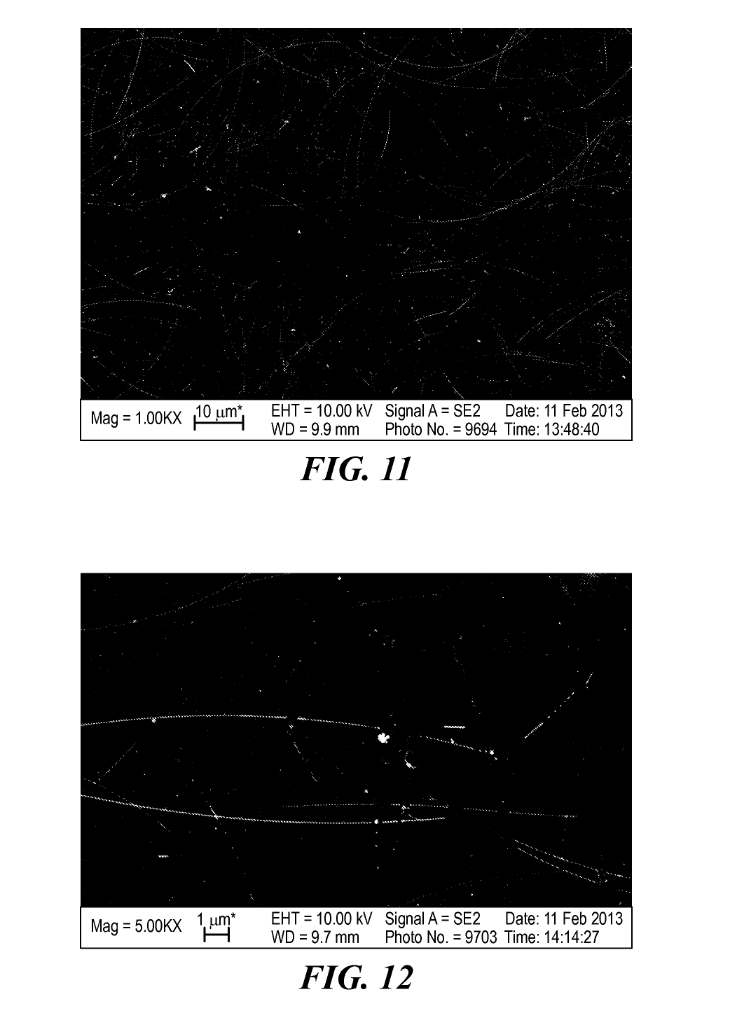

A sample of an electrically conductive film comprising silver nanowires having an average diameter of between about 10 nm to about 40 nm or between about 20 nm to about 40 nm was provided. A polarized ultraviolet diode pumped solid state laser operating at a wavelength of 355 nm, pulse duration of 30 nanoseconds and a polarization ratio of 100:1 was used (i.e., the power of the emitted beam aligned in a primary direction was 100 times that of the power aligned in a direction perpendicular to the primary direction). Other parameters of laser operation include a spot size of 40 μm, scan speed of 1200 mm/s, repetition rate of 60 kHz, and pulse energy of 7.5 μJ. Using such a laser operating at the conditions stated above, a sample of an electrically conductive film was irradiated along a line. FIGS. 11 and 12 show scanning electron microscope images of the electrically conductive film after laser irradiation at magnifications of 1000 times and 5000 times, respectively. More of the nanowires that were oriented orthogonal to the direction of polarization (e.g. vertical direction) than nanowires oriented in the same direction as the direction of polarization (e.g. horizontal direction) were ablated. FIGS. 11 and 12 show less damage to the polymer around the nanowires along the laser patterned line than FIGS. 9 and 10 or FIGS. 7 and 8.

### Example 5

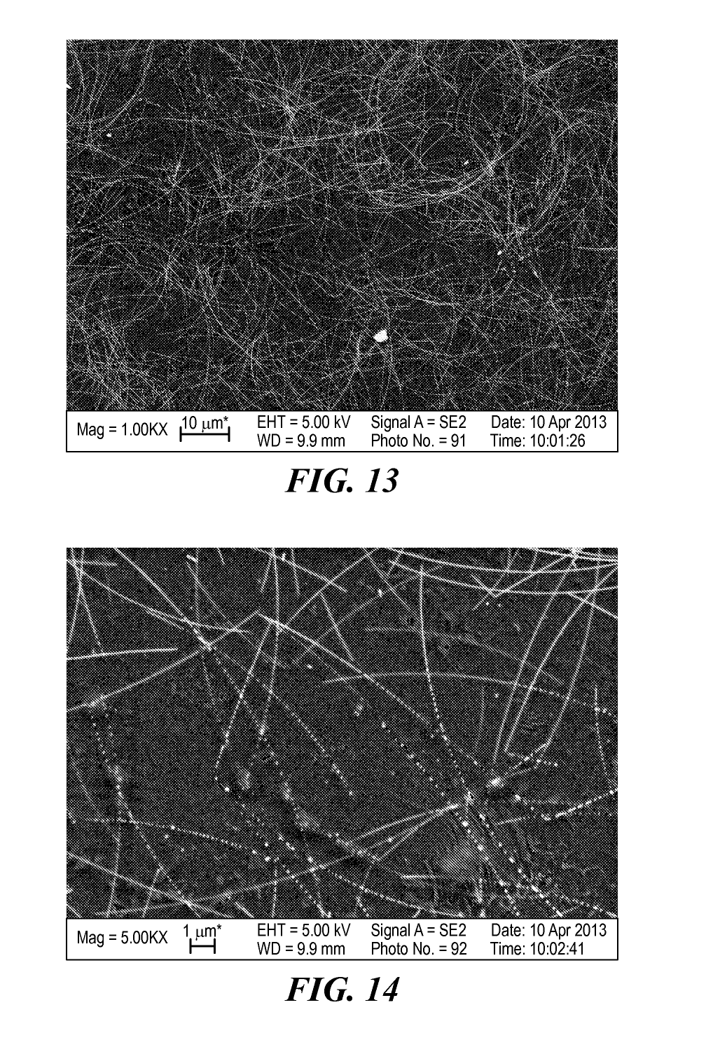

A sample of an electrically conductive film comprising silver nanowires having an average diameter of between about 10 nm to about 40 nm or between about 20 nm to about 40 nm was provided. A polarized ultraviolet laser operating at a wavelength of 355 nm and a pulse duration of 10 picoseconds with a quarter-wave plate in the path of the beam changing it from linearly polarized to circularly polarized. Other parameters of laser operation include a spot size of 20 μm, scan speed of 3000 mm/s, repetition rate of 500 kHz, and pulse energy of 0.14 μJ. Using such a laser operating at the conditions stated above, a sample of an electrically conductive film was irradiated using a laser power of 0.07 W along a line. After irradiation, the electrically conductive film was electrically isolating in the patterned area and remained invisible to the unaided eye. FIGS. 13 and 14 show scanning electron microscope images of the electrically conductive film after laser irradiation at magnifications of 1000 times and 5000 times, respectively. Nanowires exposed to radiation appear to be separated into collinear nanospheres. FIGS. 13 and 14 show less damage to the polymer around the nanowires along the laser patterned line than either the FIGS. 11 and 12 or FIGS. 9 and 10 or FIGS. 7 and 8.

### Example 6

A roll of an electrically conductive film comprising silver nanowires having an average diameter of between about 10 nm to about 40 nm or between about 20 nm to about 40 nm was provided. The roll of film was about 100 m long and 0.5 m wide. Samples of film having approximate dimensions of 200 mm by 125 mm were cut from the roll. FIG. 15A shows the roll of film, and FIG. 15B shows the sample of film cut from the roll. Isolating lines were formed on the film sample as discussed in the method section above. A method for determining the minimum power to produce TD isolating lines was provided above. Table 1 shows the minimum power to produce isolating lines in the TD for several runs of the experiment. A method for determining the minimum power to produced MD isolating lines was provided above. Table 2 shows the minimum power to produce isolating lines in the MD for several runs of the experiment.

Comparing Tables 1 and 2, the minimum power required to produce isolating MD lines was generally less than the minimum power required to produce isolating TD lines. A lower power to isolate lines oriented parallel to the polarization of a UV laser means that the pulse energy was less and we observe that there was less damage to the surrounding polymer when using smaller pulse energies.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the claims that issue from this application, and all changes that come within the meaning and range of equivalents thereof are intended to be embraced therein.

TABLE 1

| | Minimum Power |
|---|---|
| Run | to Isolate (W) |
| 1 | 0.256 |
| 2 | 0.256 |
| 3 | 0.283 |
| 4 | 0.283 |
| 5 | 0.283 |
| 6 | 0.283 |
| 7 | 0.23 |
| 8 | 0.23 |
| 9 | 0.243 |
| 10 | 0.243 |
| 11 | 0.243 |
| 12 | 0.256 |
| 13 | 0.256 |
| 14 | 0.27 |
| 15 | 0.218 |
| 16 | 0.23 |
| 17 | 0.243 |
| 18 | 0.243 |
| 19 | 0.243 |
| 20 | 0.256 |
| 21 | 0.256 |
| 22 | 0.27 |
| 23 | 0.246 |
| 24 | 0.246 |
| 25 | 0.26 |
| 26 | 0.26 |
| 27 | 0.26 |
| 28 | 0.273 |
| 29 | 0.273 |
| 30 | 0.273 |

TABLE 2

| | Minimum Power to |
|---|---|
| Run | Isolate (W) |
| 1 | 0.181 |
| 2 | 0.181 |
| 3 | 0.193 |
| 4 | 0.193 |
| 5 | 0.193 |
| 6 | 0.193 |
| 7 | 0.193 |
| 8 | 0.193 |
| 9 | 0.197 |
| 10 | 0.204 |
| 11 | 0.21 |
| 12 | 0.216 |
| 13 | 0.223 |
| 14 | 0.223 |
| 15 | 0.185 |
| 16 | 0.185 |
| 17 | 0.185 |
| 18 | 0.185 |
| 19 | 0.185 |
| 20 | 0.191 |
| 21 | 0.191 |

What is claimed:

1. A method comprising:
providing an electrically conductive film comprising a first set of electrically conductive nanostructures in a first region that exhibits a first conductivity and a second set of electrically conductive nanostructures in a second region that exhibits a second conductivity, and
irradiating the first region of the electrically conductive film with a polarized laser beam having an ultraviolet light frequency at a pulse duration less than 100 nanoseconds,
wherein, after irradiating the first region of the electrically conductive film, the first region exhibits a third conductivity that is less than the second conductivity.

2. The method according to claim 1,
wherein the electrically conductive film comprises a top coat layer disposed on an electrically conductive layer that comprises the first set of electrically conductive nanostructures and the second set of electrically conductive nanostructures, and
wherein, after irradiating the first region of the electrically conductive film, the top coat layer exhibits minimal damage.

3. The method according to claim 2,
wherein the electrically conductive film comprises a substrate, the electrically conductive layer being disposed on the substrate, and
wherein, after irradiating the first region of the electrically conductive film, the substrate exhibits minimal damage.

4. The method according to claim 3,
wherein the electrically conductive film comprises a hard coat layer, the substrate being disposed on the hard coat layer, and
wherein, after irradiating the first region of the electrically conductive film, the hard coat layer exhibits minimal damage.

5. The method according to claim 1, wherein the first set of electrically conductive nanostructures and the second set of electrically conductive nanostructures comprise silver nanowires.

6. The method according to claim 1, wherein the silver nanowires has an average diameter, the average diameter being between about 10 nm and about 40 nm.

7. The method according to claim 1, wherein the laser beam is linearly polarized.

8. The method according to claim 1, wherein the laser beam is radially polarized.

9. The method according to claim 1, wherein the laser beam is circularly polarized.

10. The method according to claim 1, wherein the polarized light beam has an ultraviolet light frequency of between about 350 nm and about 400 nm.

11. The method according to claim 1, wherein the polarized light beam has an ultraviolet light frequency of about 355 nm.

12. The method according to claim 1, wherein the pulse duration is less than about 1 nanosecond.

13. The method according to claim 1, wherein the pulse duration is less than about 100 picoseconds.

14. The method according to claim 1, wherein the pulse duration is less than about 15 picoseconds.

15. The method according to claim 1, wherein the pulse duration is less than about 10 picoseconds.

16. A method comprising:
providing an electrically conductive film comprising a first set of electrically conductive nanostructures in a first region that exhibits a first conductivity and a second set of electrically conductive nanostructures in a second region that exhibits a second conductivity, and
irradiating the first region of the electrically conductive film with a polarized laser beam having a polarization direction, wherein at least one of the electrically conductive nanostructures in the first set of electrically conductive nanostructures in the first region has an orientation direction that is aligned substantially parallel to the polarization direction,
wherein, after irradiating the first region of the electrically conductive film, the first region exhibits a third conductivity that is less than the second conductivity.

17. The method according to claim 16, wherein the polarized laser beam has a visible or infrared light frequency.

18. The method according to claim 16, wherein the polarized laser beam has a visible light frequency of about 532 nm.

19. The method according to claim 16, wherein the polarized laser beam has an infrared light frequency of about 1064 nm.

20. The method according to claim 16,
wherein the electrically conductive film comprises a top coat layer disposed on an electrically conductive layer that comprises the first set of electrically conductive nanostructures and the second set of electrically conductive nanostructures, and
wherein, after irradiating the first region of the electrically conductive film, the top coat layer exhibits minimal damage.
